(19) United States
(12) Patent Application Publication
(10) Pub. No.: US 2005/0100314 A1
(43) Pub. Date: May 12, 2005

(54) Method of recording and reproducing video and audio stream

(76) Inventors: Ching-Ying Huang, Jhongli City (TW); Jiun-Shiung Chen, Su-ao Town (TW)

Correspondence Address: Raymond Sun, 12420 Woodhall Way, Tustin, CA, 92782, US

(21) Appl. No.: 10/980,062

(22) Filed: Nov. 2, 2004

(30) Foreign Application Priority Data
Nov. 6, 2003 (TW) 92131144

(51) Int. Cl. H04N 5/76

(52) U.S. Cl. 386/46; 386/95

(57) ABSTRACT

A method of recording and reproducing combined data which includes groups of a first type of data and groups of a second type of data includes embedding marks at the locations where the type of data to be omitted starts and ends. When reproduction of the video/audio data reaches a mark, the reproduction can automatically skip to the next mark, thereby omitting the selected video/audio data during reproduction.

### BACKGROUND OF THE INVENTION

1. Field of the Invention

The present invention relates to a method of recording and reproducing video/audio data. In particular, the present invention relates to a method of skipping specified video/audio data when reproducing video/audio data.

2. Description of the Prior Art

Accompanying the vigorous development of multimedia technology, high-quality multifunctional video/audio products have become increasingly popular. Of these video/audio products, DVD or VCD recorders/players are used for viewing programs at any time, so that viewers will not miss their favorite programs.

To record or play back TV signals, such as National Television System Committee (NTSC) and Phase Alternation Line (PAL), the signals are input to an input terminal of a DVD or VCD recorder/player. The tuner of the DVD or VCD recorder/player demodulates the signal and converts the analog video/audio data into digital video/audio data. After connecting the DVD or VCD recorder/player to a display unit, it is possible to use the REC button or PLAY button on the DVD or VCD recorder/player to record and play back programs.

However, sometimes the user does not want to view certain video/audio data, such as the video/audio data for commercials from the video/audio data recorded by the DVD or VCD recorder/player. Current DVD or VCD recorders/players also record the video/audio data of commercials accompanying a given program when recording the given program.

FIG. 1 illustrates the recording and reproduction of conventional video/audio data. During recording, all of the video/audio data received by the DVD or VCD recorder/player is recorded sequentially on an optical disk. During reproduction, the DVD or VCD recorder/player must sequentially reproduce program video/audio data 110, followed by commercial video/audio data 120, program video/audio data 130, commercial video/audio data 140, program video/audio data 150, and so on. As used herein, the term “commercial data” shall mean commercial video/audio data, and the term “program data” shall mean program video/audio data.

Therefore, when the video/audio data is being reproduced, each time the user sees the commercial data, he or she must press the fast-forward button to jump to the next section of the program data. This results in poor use of time. Also, the program cannot be played back cohesively, and the user may not become immersed in the story.

### SUMMARY OF THE DISCLOSURE

It is an objective of the present invention to provide a method for recording and reproducing video/audio data which allows the user to skip specified video/audio data when reproducing video/audio data, so as to improve the coherence of the reproduced video/audio data.

In order to accomplish the objects of the present invention, there is provided a method of recording and reproducing combined data which includes groups of a first type of data and groups of a second type of data. The method embeds marks at the locations where the type of data to be omitted starts and ends. When reproduction of the video/audio data reaches a mark, the reproduction can automatically skip to the next mark, thereby omitting the selected video/audio data during reproduction.

In one embodiment of the present invention, marks are embedded at the locations where the video/audio data to be omitted start and end. When reproduction of the video/audio data reaches a mark, the reproduction can automatically skip to the next mark. In this way, the user can omit selected video/audio data when viewing a program to improve the coherence of the reproduced video/audio data.

### BRIEF DESCRIPTION OF THE DRAWINGS

FIG. 1 illustrates the recording/reproducing of conventional video/audio data.

FIG. 2 is a diagram illustrating the marks added into video/audio data according to the present invention.

FIG. 3 is a flow chart of a method according to the present invention for reproducing video/audio data with embedded marks.

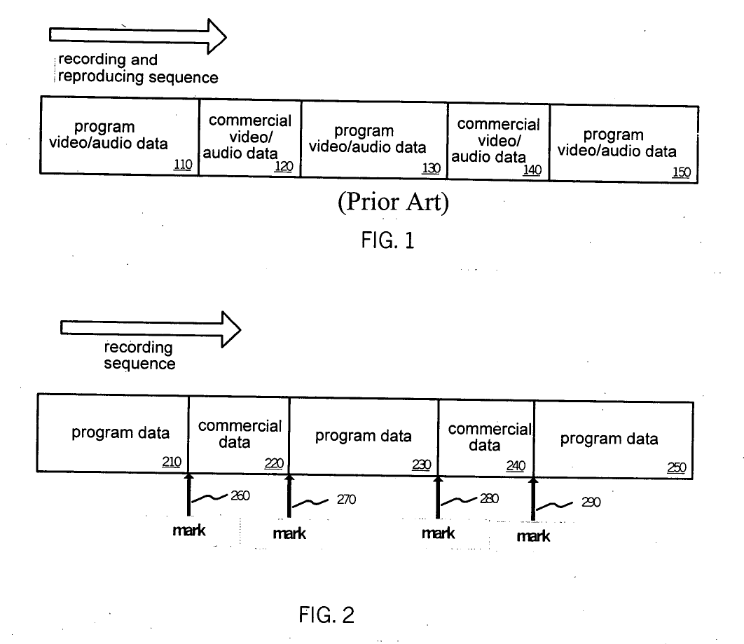

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

The present invention provides a method for recording and reproducing video/audio data which allows the user to skip specified video/audio data, such as the video/audio data of commercials, when reproducing video/audio data, so as to improve the coherence of the reproduced video/audio data. In particular, some marks are added at selected locations during the recording process of an optical disk to divide the optical disk into appropriate sections. Depending on these marks, the user can use the “Skip” button on the optical disk player to search quickly through the contents of different sections.

FIG. 2 illustrates the marks added into the video/audio data. The recording sequence is such that program data 210 is recorded, followed by commercial data 220, program data 230, commercial data 240, program data 250, and so on. Marks 260 and 270 are added at the location where commercial data 220 starts and the location where commercial data 220 ends, respectively. In addition, marks 280 and 290 are also added at the location where commercial data 240 starts and the location where commercial data 240 ends, respectively. In other words, when a user uses the recording function, the DVD or VCD recorder/player will add marks at the beginning location and ending location of all commercial data among the video/audio data.

The beginning location and ending location of all commercial data can be detected or recognized by one of many known schemes. For example, a specific tone can be used to identify the start of the commercial data. As another example, in the VPS System in Germany, a signal is contained in the television signals to identify the program data. Both of these examples attempt to distinguish the commercial data from the program data within the oncoming television signals. Another type of scheme involves generating a learning mechanism by analyzing the variation in the spectrum between the program data and the commercial data. As an example, the commercial data may have a greater weighting in the band of high frequencies, and the program data may have a greater weighting in the band of low frequencies.

In an ordinary VCD or SVCD disc, the added marks show the index of the VCD or SVCD. In a DVD disc, the added marks show the title or chapter of the DVD.

There are three main methods that DVD or VCD recorders/players can use to add the marks. A first method is for the DVD or VCD recorders/player to automatically embed marks at the beginning and the end of each commercial data during the recording process as described above. According to a second method, after all of the video/audio data has been recorded, the DVD or VCD recorder/player sequentially searches the section of each commercial data and then adds the marks. In a third method, the user can manually add marks to the commercial data that he or she does not want to watch. The user can add these marks during the recording of the program, or during any playback of the program.

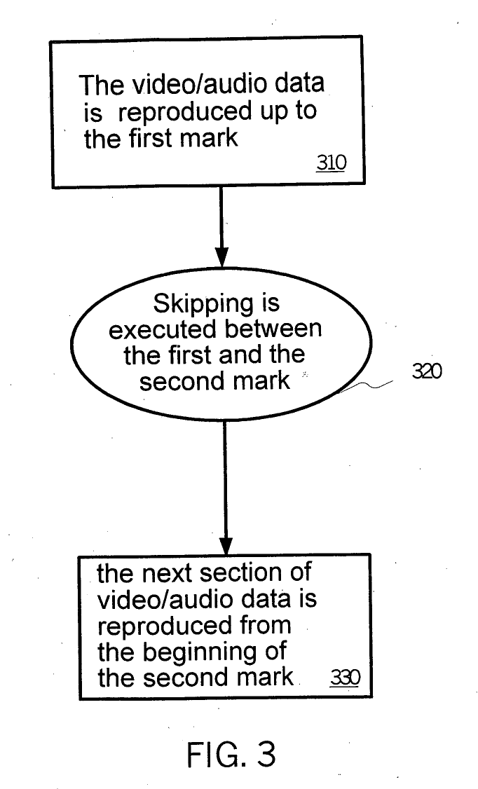

FIG. 3 shows a flow chart for reproducing video/audio data that has embedded marks. In a first step 310, when the DVD or VCD recorder/player reproduces (i.e., plays or records) video/audio data outside of a pair of embedded marks, the player reproduces the video/audio data up to the first mark. At the first mark, in step 320, the DVD or VCD recorder/player skips to the second mark. The commercial data would be between the first and second marks of this pair of embedded marks. Finally, in step 330, the DVD or VCD recorder/player starts to reproduce the next section of video/audio data from the beginning of the second mark. The same process then repeats itself when the next pair of embedded marks is encountered.

After the user reproduces the video/audio data up to a mark, he or she can select the skip function to skip to the next mark. Then, the DVD or VCD recorder/player will start to reproduce the next section of video/audio data from the next mark. In particular, the marks can be embedded at the beginning and end of the commercial video/audio data. In this way, the recorded video/audio data can be reproduced continuously without being interrupted by commercials.

When the player plays a program with commercials, the user can use the mark embedding method disclosed in the present invention to directly skip the commercials that he or she does not want to watch. This can improve the time utilization efficiency. Also, the program can be played coherently without being interrupted so that the user can become immersed in the story.

Consequently, the advantage of the present invention is that the consumer can omit the parts of specified video/audio data when watching a program to improve the coherence of the reproduced video/audio data.

Although the present invention is described in terms of marking video/audio data to distinguish program data from commercial data, the principles of the present invention can also be applied to other types of data that require segregation.

While the description above refers to particular embodiments of the present invention, it will be understood that many modifications may be made without departing from the spirit thereof. The accompanying claims are intended to cover such modifications as would fall within the true scope and spirit of the present invention.

1. A method of recording combined data which includes groups of a first type of data and groups of a second type of data, comprising:
a. embedding a first mark at the occurrence of a group of the second type of data, and a second mark at the end of the group of the second type of data; and
b. repeating step (a) for all groups of the second type of data.

2. The method of claim 1, wherein the first type of data is program video/audio data, and the second type of data is commercial video/audio data.

3. A method of recording and reproducing combined data which includes groups of a first type of data and groups of a second type of data, comprising:
a. embedding a first mark at the occurrence of a first group of the second type of data, and a second mark at the end of the first group of the second type of data;
b. repeating step (a) for all groups of the second type of data;
c. reproducing the combined data up to the first mark of a first group of the second type of data;
d. at the first mark, skipping to the second mark for the first group of the second type of data; and
e. repeating steps (c) and (d) until reproduction of the combined data is completed.

4. The method of claim 3, wherein the first type of data is program video/audio data, and the second type of data is commercial video/audio data.

5. A method of recording and reproducing video/audio data stream which includes at least one specified video/audio data, comprising:
a. embedding a first mark at the occurrence of the specified video/audio data; and
b. embedding a second mark at the end of the specified video/audio data.

6. The method of claim 5, wherein the specified video/audio data is commercial video/audio data.

7. The method of claim 5, wherein the first mark and the second mark are embedded in each of the specified video/audio during recording.

8. The method of claim 5, wherein the first mark and the second mark are manually embedded in each of the specified video/audio after recording.
